(19) United States
(12) Patent Application Publication
(10) Pub. No.: US 2016/0240987 A1
(43) Pub. Date: Aug. 18, 2016

(54) Braided decorative electrical extension cord

(71) Applicant: GLOBE ELECTRIC COMPANY INC., Montreal (CA)

(72) Inventor: Adam Chaimberg, Hampstead (CA)

(73) Assignee: GLOBE ELECTRIC COMPANY INC.

(21) Appl. No.: 14/545,235

(22) Filed: Apr. 13, 2015

(30) Foreign Application Priority Data
Feb. 17, 2015 (CA) 2882024

(51) Int. Cl. H01R 27/02; H01B 7/04

(52) U.S. Cl. CPC H01R 27/02; H01B 7/04

(57) ABSTRACT

An electrical extension cord having a flexible electrical cable covered with a braided material formed by a plurality of filaments or ribbons disposed in tight fit about the flexible cable. The braided material is of uniform color or a pattern of colors to provide an aesthetic and decorative appearance as well as a smooth texture. Colored connectors are secured to opposed ends of the flexible electrical cable.

### TECHNICAL FIELD

The present invention relates to electrical extension cords and particularly to a decorative, aesthetically eye pleasing, and flexible extension cord.

### BACKGROUND OF THE INVENTION

Electrical extension cords are well known in the art and it is also known to have different types of connectors secured to the ends of the cord. Most of these extension cords are for outdoor use. When these are used indoors, it is common to try and conceal these cords on the floor surface close to the wall and behind furniture pieces as they are unpleasant to look at. When concealing the cords under carpets they form bulges which is also unpleasant to the eye. These extension cords are also formed from hard polymeric material to provide protection against sharp objects which could cut into the cable and the inner conductive wires. Because of this hard covering material, the extension cord is not very flexible and retains curved shapes due to they usually being stored in a wound bundle form.

### SUMMARY OF THE INVENTION

It is a feature of the present invention to provide a braided decorative electrical extension cord which substantially overcomes the above mentioned problems of the prior art electrical extension cords.

It is a further feature of the present invention to provide a braided decorative electrical extension cord which is pleasant to the eye, has a decorative appearance and is highly flexible.

A further feature of the present invention is to provide a braided decorative electrical extension cord wherein the braided outer surface of the cable is formed of colored fabric or fabric like polymeric material of uniform color or patterns of color and wherein the connectors at the end of the cord are of a complimentary color.

According to the above mentioned features, from a broad aspect the present invention provides an electrical extension cord comprising a pair of electrical conductors enclosed in an electrically insulating and flexible material to form a flexible cable. A braided material is disposed about the flexible cable and is immovably secured at opposed ends thereof into injected molded electrical connectors. The filaments of the braided material provide an aesthetically pleasing appearance and a smooth texture and enhances the flexibility of the cable.

### DESCRIPTION OF THE DRAWINGS

A preferred embodiment of the present invention will now be described with reference to the accompanying drawings in which:

FIG. 1 is a fragmented perspective view of the braided decorative electrical extension cord of the present invention;

FIG. 2 is an end view of the braided electrical cable showing its internal construction without a connector secured thereto:

FIG. 3 is an end view of FIG. 2:

FIG. 4 is a simplified diagrammatic view of the braiding process;

FIG. 5 is a sectional side view of the braided cable wherein some of the filaments or ribbons are of a different color(s), and

FIG. 6 is a plan view of a power bar connector.

### DESCRIPTION OF THE PREFERRED EMBODIMENT

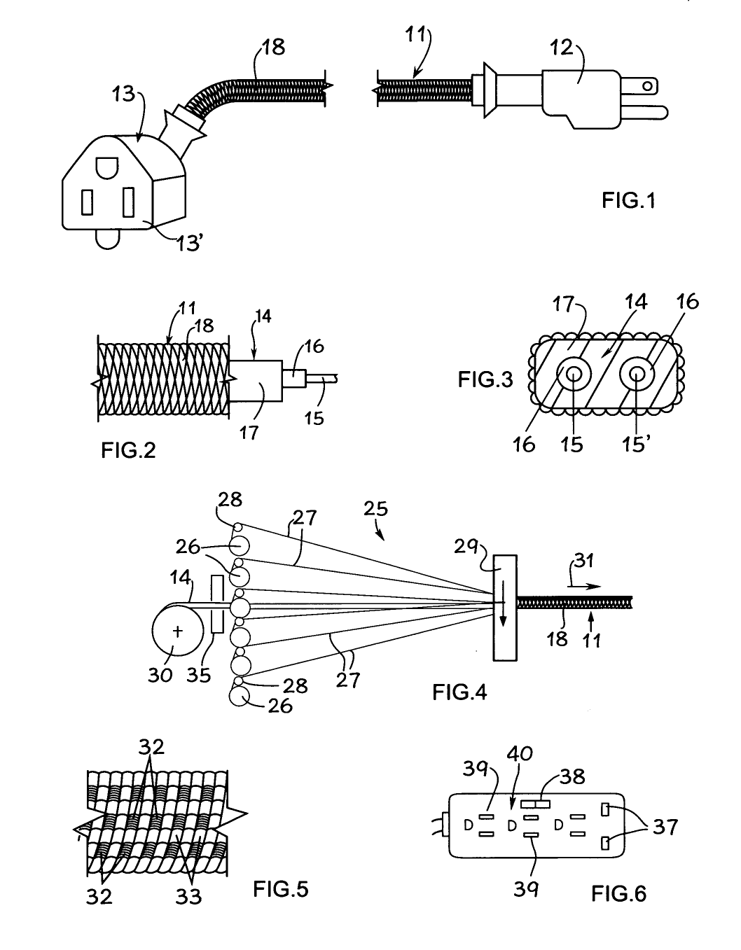

Referring now to the drawings and more specifically to FIGS. 1 to 3, there is shown generally at 10 the braided decorative electrical extension cord of the present invention. It is comprised of a braided cable 11 having connectors 12 and 13 secured to respective ones of the opposed ends of the braided cable. Although the connectors herein shown are comprised of a male plug connector 12 and an outlet connector 13 having electrical power sockets 13′ for supplying electrical power. Other type of outlet connectors are contemplated.

As shown in FIGS. 2 and 3, the electrical extension cord is formed from a standard two wire electrical cord 14 comprised of a pair of conductors 15 and 15′ disposed in side-by-side relationship and each encapsulated or embedded in an outer electrically insulating sleeve 16 which is also molded in an electrically insulating outer cover 17 which may be formed of elastomeric or resinous material or a silicone rubber material. A ground wire (not shown) may also be disposed in the elastomeric material at a precise position if the cable is a grounded cable. Alternatively, the two wires 15 and 15′ may be molded directly within the elastomeric material which is electrically insulating. The elastomeric material provides high flexibility to the electrical cord 14. The electrical cord 14 is fed through a braiding machine 25, as schematically illustrated in FIG. 4, where a braided material covering 18 is formed about the electrical cord. As shown in FIG. 3, the cable 11 is a substantially flat rectangular cable but it could also have a circular cross-sectional shape.

As illustrated in FIG. 4, the braiding machine 25 has a plurality of spools 26 each provided with filaments or narrow ribbons 27 trained about one or more guide spools, only one guide spool 28 illustrated herein to guide the filaments or ribbons 27 in a winding spinning device 29 which weaves the filaments or ribbons about the cable 14 which is pulled from a cable spool 30 through the winding spinning device 29, in the direction of arrow 31, to form the braided cover 18. The filaments or ribbons are colored to form a colored extension cord with the connectors 12 and 13 being of a complimentary color. Some of the spools 26 may contain filaments or ribbons of different colors whereby to weave a pattern of colored filaments or ribbons about the flexible cable 11. FIG. 5 illustrates a pattern of different colored filaments or ribbons wherein the different colored ribbons 32 appear in a repeat sequence amongst the other ribbons 33 which are of a different uniform color.

The braided filaments or ribbons are tightly wound about the cable 14 but in an alternative embodiment a glue may be applied to the cable by a gluing machine 35 disposed at a convenient position along the travel path of the cable 14 before it enters the winding spinning device 29 to assure that the braided material is firmly attached to the outer surface of the cable 14.

In the manufacture of the braided electrical extension cord illustrated in FIG. 1, a specific length of braided cable 11 has end portions thereof striped and positioned in an injection molding mould to connect to the metal blades, blade receptacles and ground prong and ground receptacle with a portion of the cable with its braided outer covering extending in the mould wherein the injected elastomeric material binds the braided material to the connectors 12 and 13.

Although FIG. 1 shows the connectors 12 and 13 as being male and female electrical connectors, other connectors may be utilized instead of the female connector. For example, a power bar 40 as illustrated in FIG. 6 containing two or more female connectors 39 may be secured to the cable 11 instead of the connector 13. The power bar 40 may also have a switch 38 and USB ports 37 or other type of power sockets.

It is within the ambit of the present invention to cover any other obvious modifications provided such modifications fall within the scope of the appended claims.

1. An indoor electrical extension cord comprising a pair of electrical conductors embedded in an electrically insulating flexible material to form a flexible cable, and a decorative braided material formed by a plurality of filaments or ribbons disposed in tight fit about said flexible cable, said braided material about said flexible cable being immovably secured at opposed ends into injected molded electrical connectors to thereby conceal said flexible cable between said molded electrical connectors, said filaments of said braided material providing an aesthetically pleasing appearance and smooth texture and enhance flexibility to said cable of said extension cord.

2. The electrical extension cord as claimed in claim 1 wherein said pair of conductors are disposed in side-by-side spaced relationship and molded in said electrically insulating flexible material to form a substantially flat cable of rectangular cross-section or cables of circular cross-sectional shape.

3. The electrical extension cord as claimed in claim 1 wherein there is further provided a ground wire embedded in said electrically insulating flexible material and spaced from said pair of electrical conductors.

4. The electrical extension cord as claimed in claim 1 wherein said electrically insulating flexible material is one of a molded elastomeric material, a resinous material and a silicone rubber material or similar materials having electrically insulating properties and flexibility.

5. The electrical extension cord as claimed in claim 1 wherein said filaments or ribbons are colored filaments to thereby form a colored extension cord.

6. The electrical extension cord as claimed in claim 5 wherein some of said filaments or ribbons are of different color whereby to form a color pattern flexible cord.

7. The electrical extension cord as claimed in claim 1 wherein said electrical connectors are comprised of a male plug connector molded at one of said opposed ends to said flexible cable and a receptacle connector at the other of said opposed ends of said flexible cable having an electrical outlet for supplying electric power.

8. The electrical extension cord as claimed in claim 1 wherein said electrical connectors are comprised by a male plug connector molded at one of said opposed ends of said flexible cable and a power bar molded at the other of said opposed ends of said flexible cable.

9. The electrical extension cord as claimed in claim 8 wherein said power bar has two or more electrical outlets, a power switch, one or more USB ports, one or more data ports, including but not limited to, Ethernet jacks and coaxial connectors.

10. The electrical extension cord as claimed in claim 5 wherein said filaments or ribbons are formed on one of elastomeric material, fabric material and resinous material, in thread or ribbon shape.
